(19) United States
(12) Patent Application Publication
(10) Pub. No.: US 2024/0364558 A1
(43) Pub. Date: Oct. 31, 2024

(54) SYSTEM AND METHOD FOR PROVIDING HIGH-TECH HOME FURNITURE AND APPLIANCES

(71) Applicants: William Pamphile, II, Malden, MA (US); Lande Pamphile, Malden, MA (US); William Pamphile, Malden, MA (US); Willande Pamphile, Malden, MA (US); Wilmayer Pamphile, Malden, MA (US)

(72) Inventors: William Pamphile, II, Malden, MA (US); Lande Pamphile, Malden, MA (US); William Pamphile, Malden, MA (US); Willande Pamphile, Malden, MA (US); Wilmayer Pamphile, Malden, MA (US)

(21) Appl. No.: 18/307,050

(22) Filed: Apr. 26, 2023

(51) Int. Cl. H04L 12/28

(52) U.S. Cl. CPC H04L 12/2816; H04L 2012/2841; H04L 2012/285

(57) ABSTRACT

A system and method for providing high tech furniture for a home is disclosed. In general, the system includes a house server, a database, and multiple controllers. The house server is connected to the database, and the controllers are connected to the house server and the database by a wireless hotspot. The controllers include a dining room controller, a kitchen controller, and a bedroom controller. The controllers and the various high tech furniture and appliances are operable to perform the steps of a method. These method steps are typically carried out by one or more central processing units and/or microprocessors located within the various home furniture and appliances.

### TECHNICAL FIELD

This application relates in general to a system and method for providing home automation, and more specifically, to a system and method for providing high tech furniture and appliances for a home.

### BACKGROUND

Existing home furniture and appliances can be re-designed to make a lifestyle for a better tomorrow. Residents of a home with high tech furniture are busy and need a home that allows them to relax after a long day of work. Current homes require individuals to perform many tasks each evening associated with making and consuming meals and cleaning and maintaining the home. At the same time, residents desire to entertain themselves with their loved ones over dinner because eating together gives people the chance to pray together, check-in with each other, talk, laugh, sing, and listen to some beautiful music. Current homes are not designed and built to allow these activities to occur without daily effort.

Therefore, a need exists for a system and method for providing high tech furniture for a home. The present invention attempts to address the limitations and deficiencies of existing homes and internal systems according to the principles and components disclosed herein.

### SUMMARY

In accordance with the present invention, the above and other problems are solved by providing a system and method for providing high tech furniture for a home according to the principles and example embodiments disclosed herein.

In one aspect, the present invention is a system for providing high tech furniture for a home. In this aspect, the home has a dining room, a kitchen, and a bedroom, and system includes a house server, a database, and multiple controllers. The house server is connected to the database, and the controllers are connected to the house server and the database by a wireless hotspot. The controllers include a dining room controller, a kitchen controller, and a bedroom controller. The system also includes a food tray dispenser that contains food items in multiple locations, and the kitchen controller is operable to record the locations for the food items. The food tray dispenser has a central processing unit that is operable to instruct the food tray dispenser to move from the kitchen to the dining room. Once in the dining room, the food tray dispenser is operable to connect to a table, and the dining room controller is operable to receive inputs selecting the food items from the food tray dispenser. Once the food is selected, the food tray dispenser is operable to dispense the selected food to a dispersal and retrieving center located on the table.

In another aspect, the present invention is a method for using a system providing high tech furniture for a home. In this aspect, the home has a dining room, a kitchen, and a bedroom, and the system has a house server, a database, and multiple controllers. The house server, the database, and the controllers are interconnected by a wireless hotspot, and the controllers include a dining room controller, a kitchen controller, and a bedroom controller. The method includes multiple steps, and the steps include the following: loading a food tray dispenser with food items; serving the food items to a dispersal and retrieving center on a table by the food tray dispenser; retrieving dirty plates from the dispersal and retrieving center by the food tray dispenser; and cleaning the dirty plates by a waste removal system integral with the food tray dispenser.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system and method for providing high tech furniture for a home according to the present invention.

FIG. 2 illustrates an example embodiment of a kitchen-dining room using a system and method for providing high tech furniture for a home according to the present invention.

FIG. 3 illustrates an example embodiment of a bedroom made using a system and method for providing high tech furniture for a home according to the present invention.

FIG. 4 illustrates a computing system of software components for providing high tech furniture for a home according to the present invention.

FIG. 5 illustrates a generalized schematic of a programmable processing system utilized as the various computing components described herein used to implement an embodiment of the present invention.

### DETAILED DESCRIPTION

This application relates in general to a system and method for providing home automation, and more specifically, to a system and method for providing high tech furniture for a home according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a media player, set-top box, smartphone, tablet, and/or web browser on any computing device.

The terms “customer,” “client,” and “user” refer to an entity, e.g. a human, using the high tech furniture system for a home including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are including below in this application.

The terms “communicate” or “communication” refer to any component(s) connecting with any other component(s) in any combination for the purpose of the connected components to communicate and/or transfer data to and from any components and/or control any settings.

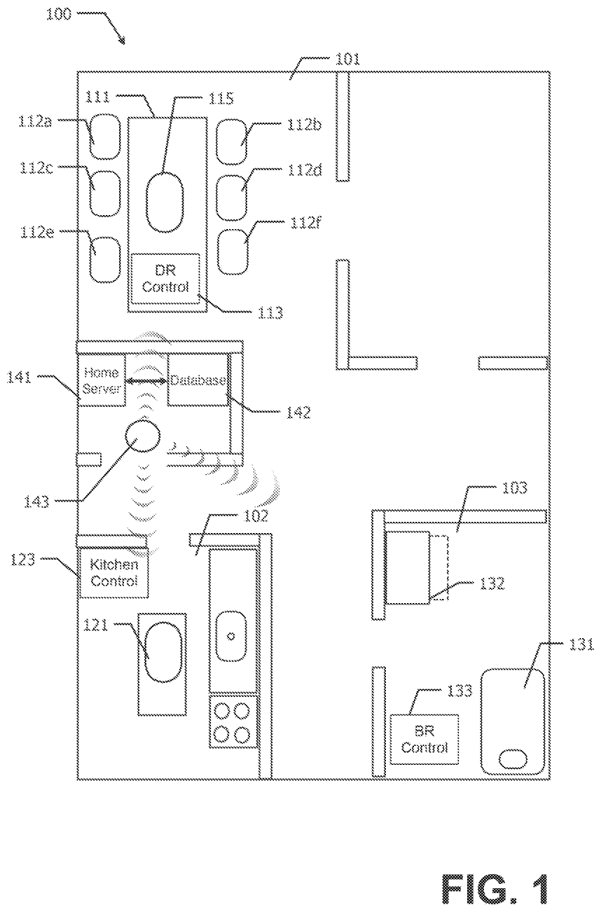

In general, the present disclosure relates to a system and method for providing high tech furniture for a home. To better understand the present invention, FIG. 1 illustrates an example embodiment of a system and method for providing high tech furniture for a home according to the present invention. A high tech house 100 comprises at least a high tech dining room 101, a high tech kitchen 102, and one or more high tech bedrooms 103. A house server 141 having an attached database 142 is located somewhere in the house 100 and is communicatively connected to client controllers in each room using a wireless network accessible via a connecting hotspot 143. The wireless network may comprise a WiFi network in a preferred embodiment. Other wireless communications networks including Bluetooth™M, LTE, 3G, 5G, and similar cellular networks also may be used.

The client controllers include a dining room controller 113, a bedroom controller 133, and a kitchen controller 123 that dynamically interact with the house server 141 to control the functions of the high-tech furniture throughout the house 100. The dining room controller 113 receives commands from the house server 141 and operates a serving table 111 and its dispersal and retrieving center 115 that is built into the table 111. The dispersal and retrieving center 115 interacts with a cool and hot food tray dispenser 121 that is loaded with food items for serving to individuals seated in chairs 112a-f while using the serving table 111. All dining chairs 112a-f can be height adjusted by pushing a button so clients can sit comfortably. Under each chair 112a-f there are very small electronic wheels to move the chair to charge automatically under the table 111 when battery is low. On the top of each chair 112a-f, there may be two blinking lights, one red and one green. A red light indicates that the battery is getting low, and a green light indicates that the chair is fully charged. The charger is a magnet charger under the table 111.

The cool and hot food tray dispenser 121 connects to the dispersal and retrieving center 115 to transfer the food items from the cool and hot food tray dispenser 121 to the serving table 111 under the control of the dining room controller 113. A kitchen controller 123 is located within the kitchen to allow individuals preparing and serving a meal access to the house server 141 that communicates commands with the dining room controller 113. The kitchen controller 123 also may display information indicating the number and location of each guest seated at the table to enable the users to indicate which items within the cool and hot food tray dispenser 121 are to be transferred to appropriate individuals seated at the serving table 111.

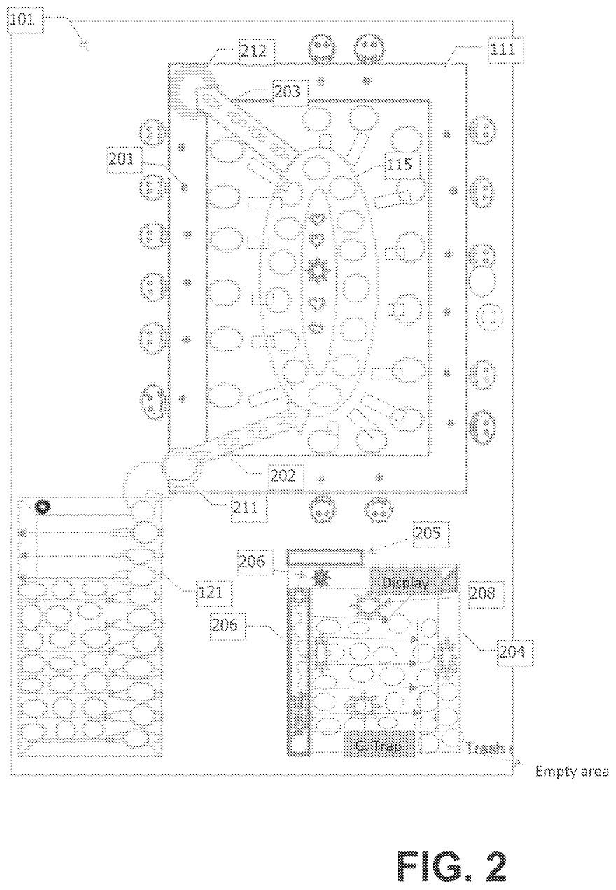

When a user loads the cool and hot food tray dispenser 121 in the kitchen, the identity and location of the loaded food items may be entered into the kitchen controller 123. A loaded cool and hot food tray dispenser 121 may be moved from the kitchen 102 to the dining room 101 and connected to the dispersal and retrieving center 115. The food items may then be transferred by the dispersal and retrieving center 115 from the cool and hot food tray dispenser 121 to the guests under the control of the kitchen controller 113. When the meal is completed, the items may be retrieved by the dispersal and retrieving center 115 from the cool and hot food tray dispenser 121 to be transferred to the kitchen 102. The cool and hot food tray dispenser 121 may also contain a waste removal system 204 as shown in FIG. 2 to clear the contents remaining on the removed dishes and then wash the dishes before they are stored in the kitchen 102. Additionally, the service table 111 may comprise a self-cleaning system, which may utilize steam and other methods to disinfect the table 111 after eating.

The waste removal system 204 may be integral to the cool and hot food tray dispenser 121 in one embodiment and may connect to the cool and hot food tray dispenser 121 that is located in the kitchen 102 to receive the returned dishes for clearing and cleaning. All of the serving and removal tasks that serve and clear a guest's seat location at the serving table 111 are performed by the various components described in detail in regard to FIG. 2.

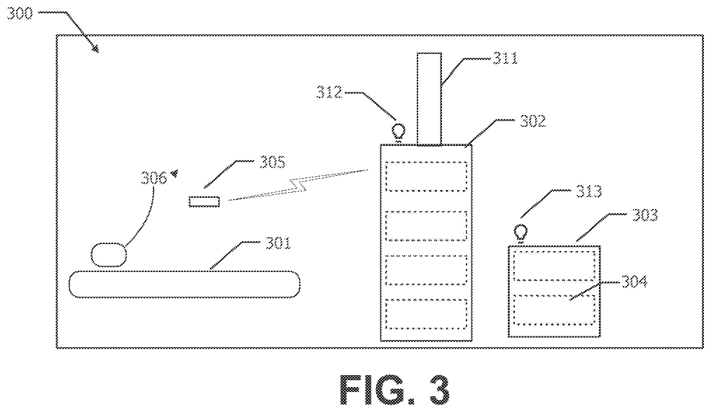

A bedroom controller 133 may be located within each of the bedrooms 103 of the house 100 to operate the various controlled items in the bedroom. For example, various lights, a repositionable bed, music and entertainment electronics and the like may be controlled and automatically operated by the bedroom controller 113. The operation of the various devices associated with the bedroom are described in detail in reference to FIGS. 3a-b herein.

The client controllers 113, 123, 133 that operate in their respective rooms may operate independently from each other and the house server 141 in one embodiment. In this first embodiment, user inputs are received in the respective rooms by the client controllers 113, 123, 133 and actions are taken under the control of instructions performed within each client controller. In an alternate embodiment, all of the command logic that determines what action is to be taken in response to a user input received by a particular client controller 113, 123, 133 may be performed within the house server 141 and commands to respond to the user commands are then sent to the specific client controller that is connected to the appropriate electronic device. In this latter embodiment, the client controllers receive use inputs, sends the user input to the house server 141, receive a responsive instruction from the house server 141, and implement the responsive instruction to a connected electronic device. One of ordinary skill in the art will recognize that different computing architectures may be implemented to perform various operations in any or all of the computing devices in the house 100.

FIG. 2 illustrates an example embodiment of a kitchen-dining room using a system and method for providing high tech furniture for a home according to the present invention. The dining room system 200 is designed to work with a hand touch opener for all the drawers in the house dining room, bedroom, kitchen, and with a high-tech dining room table that can serve breakfast, appetizers, lunch, and dinner automatically. The table has two round glass pieces in the center. The first-round circle is the table server that turns slowly around the table from right to left to serve the food plates. The small round circle in the center is to keep the sound system hidden from plain sight.

One open hole 211 and one closed hole 212 on the left side and on the right side of the table allow the dinnerware and food plates go to the table. All dinnerware, food plates, and plate servers will have a sensor and magnet in the bottom to control the plates as they are directed to where the clients are sitting. After eating, the dinnerware and plates return to the center of the table server then proceed along and off the table to a dishwasher where the dirty items are cleaned. A list of dinnerware sets and table arrangements can be selected on the database by users in advance.

The system will process the dinnerware, drinks with and without ice, and food dishes. Each of these steps should take approximately 2 to 5 minutes based on table capacity. As shown in FIG. 2, the serving table 111 comprises additional elements. Initially, the table 111 includes a plurality of buttons 201 that may be pressed by persons at the table to instruct the system to perform steps or actions. A first portion of the plurality of buttons 201 may comprise a red light, and a second portion of the plurality of buttons 201 may comprise a green light. A green button may indicate that a seat is available, and when the seat is occupied, the green button may turn red. The plurality of buttons 201 may know when seats are occupied by a plurality of sensors located within the seats or chairs 112a-f. Once the seat is occupied, a red button may be pushed once to connect a client with a kitchen representative. A red button may be pushed twice if the client finishes eating early. A red button may be pushed three times to instruct the system to pick up a used plate.

The kitchen personnel monitor the event through a database from the kitchen. If the first food dispenser is getting low, the computer will indicate the need to get another warm/hot food tray ready to the table food connector spot. The cool and hot food tray dispenser 121 will be on the side of the table 111 or under the table 111 for small events. It may be monitored with a camera as it approaches and departs from the table 111. The food dispenser 121 will roll to the open hole 211 (i.e., the food connector spot) of the table 111, and then a first clear glass roller 202 in the table rolls the food plates to the turning food server or to the seats. Each food spot plate server may have a sensor to indicate the weight of the food on the plate. When the weight of the food is decreasing, a signal is sent to the table, and the sound system asks the client if more food is needed. If the answer is yes, more food will arrive at the table from the dispenser 121.

The system can be programmed by group, by category, or by individual.
a) Serving by group. The system will serve food to everybody at the table automatically.
b) Serving by category. This is for users who request different kinds of food. Every table seat spot has a number, and that number is associated with the food tray dispenser 121. When a client requests a specific food, that food will go exactly where the client is sitting automatically, and the center of the round table will not turn around. It will turn just to serve the specific client and will stop when finished.
c) Serving by individual. The system can serve one or two or more client's food that the client has requested automatically.

After a meal, the left-over food on the table 111 will be wrapped in plastic, and dirty plates will be returned to the food tray dispenser 121 through a second clear glass roller 203 that directs to plates to the closed hole 212, which opens when the dispenser 121 connects to the table 111. The plates travel to the clear glass roller 203 via the return circle automatically. In this embodiment, the waste removal system 204 is integral to the food tray dispenser 121, and the top of the waste removal system 204 has an open/closed gate 205 to load the dirty plates. The dinnerware plates each have a magnet to hold the plates while turning upside down to go through a turning brush 206 that dumps any debris into a trash container through a chute 207, then proceeds to the dishwasher 208 automatically. Once the trash is removed from the container, it may self-cleans with the push of a button.

The dishwasher 208 includes at least two units which blow detergent, hot water, and hot air to clean and dry the dirty plates and other contents therein. In a preferred embodiment, the dishwasher may comprise a tankless water heater capable of heating water to a temperature ranging from 100° F. to 140° F. After loading the dishes, the dishwasher 208 has four (4) working cycles in ten (10) minutes. In the first cycle, the machine sprays the plates with detergent to release the grease in about one (1) minute. In the second cycle the machine steams the plates to kill bacteria and washes the dishes in about two (2) to four (4) minutes. During the third cycle the hot water rinses the plates twice in about three (3) to four (4) minutes. In the last cycle a fan blows hot air to dry the dinnerware for about one (1) minute. After cleaning, the dishwasher can move the clean dishes to the empty area in the dishwasher automatically or as requested by clients using the system display. The dishwasher has a glass door that locks when the machine is in use. The top of the dishwasher has an open and closed gate to allow the plates to go through the cleaning process automatically.

The dishwasher 208 has a grease trap locate in the front bottom. The grease trap may trap all grease from the silverware to prevent plumbing issues. There will be a sensor in the dishwasher 208 to indicate when grease trap box needs to be emptied/cleaned to prevent plumbing problems. The grease trap box is sealed to prevent leaks. In one embodiment, the dishwasher 208 has a display, cameras and can be connected to a smartphone. The smart phone can monitor the dishwasher 208 anywhere. The dishwasher trash disposal side has a cooling system which cools trash to below 31° F. It serves to keep the trash cool to prevent bad smell or bacteria. The dishwasher 208 has an empty tray in the side where all the clean silverwares moved to the empty tray automatically to make room for the next cleaning round.

When the grease trap box needs to be emptied, the sensor in the dishwasher 208 may indicate that on the display and the smartphone. Either the display or the smartphone may utilize a three light indicator concerning the grease trap box. A green light may indicate that the grease trap is cleaned. A yellow light may indicate that the grease trap is about to be full. A red light may indicate that the grease trap is full, and the washing system will stop until the grease trap is cleaned. The grease trap may have a capacity to carry one gallon of oil grease. The following process may be used to clean the grease trap:
a. Push CGT->(Clean Grease Trap) in display to clean grease trap.
b. Dishwasher system will turn off automatically.
c. The grease trap is getting warmed for about two (2) minutes to allow the grease to lose.
d. A picture of four (4) flex pipe will come out in front by the grease trap.
e. Have an empty gallon available to carry the grease from the grease trap.
f. Push on and off button in the display for the grease to come out or stop.
   When finished, the flex pipe will be back, and the green light turns back on to indicate that the system is ready to use.

FIG. 3 illustrates an example embodiment of a bedroom made using a system and method for providing high tech furniture for a home according to the present invention. FIG. 3 shows a diagrammatic view of a high tech bedroom 300. Sleeping is essential for everyone for living a meaningful life. Not getting enough sleep will mostly drain your energy and impact your life greatly. The automated bedroom uses a remote device for users to input controls.

The bedroom drawers 304 will have a hand touch sensor to open and close by a touch. Each drawer 304 will have an LED light inside the drawer. The system comes with the option to program which drawers are to open with a fingerprint to protect items such as jewelry, money, documents, and other important items. One or two users' fingerprints may be programmed. A 24-voltage electric device installed in the bottom of each drawer allows the drawers to open and close, and only two (2) drawers will open at the same time for safety reasons.

Next, the headboard 306 can be adjusted for watching movies or having breakfast in bed by touching a button at the top of the bed or on the remote device. Third, the top of the dresser, the chest, and the nightstands will have lighting 312, 313 with three different illuminations and a timer to automatically turn the lights off and on. The bottom of the bed 301, the dresser 302, and nightstand 303 all possess three different illuminations to light the floor at night.

The top of the headboard 306 and the bottom of the chest will have a sound system with a Bluetooth connection to download audiobooks and music. The dresser mirror 311 can also be used as a TV when desired. When a user falls asleep watching the TV, the screen returns to being a mirror. Each bedroom set 300 has a code, and the bedroom must be sold with the code. Users may use the code to disable the system and open drawers manually. Each nightstand 303 has four (4) USB ports and a pair of power outlets.

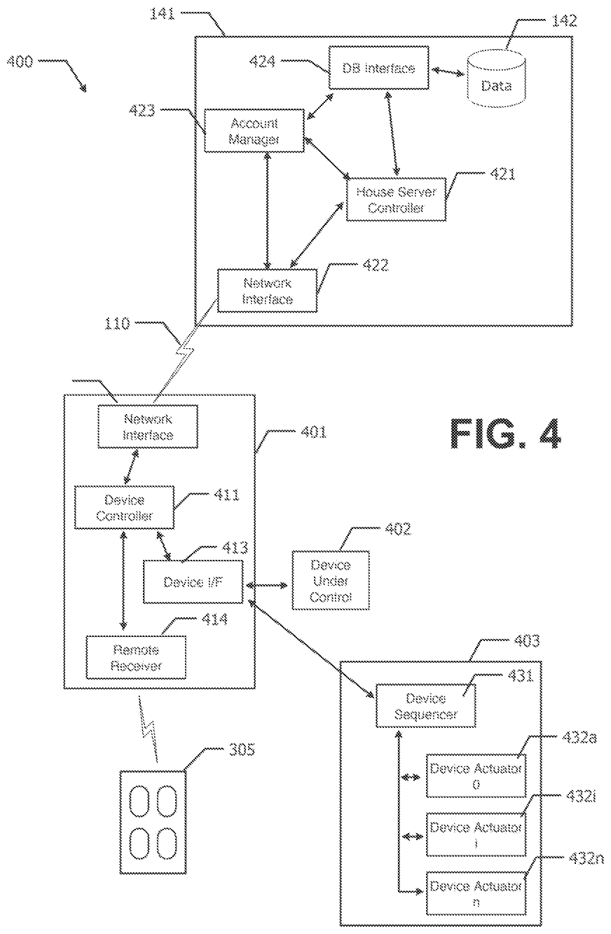

FIG. 4 illustrates a computing system of software components for providing high tech furniture for a home according to the present invention. The high-tech home computing system 400 comprises a house server 141, a plurality of client controllers 401 communicatively connected to one or more devices under control 402-403. The plurality of client controllers 401 may include the dining room controller 113, the kitchen controller 123, one or more bedroom controllers 133, and any other client control devices for controlling other automated components in the house 100. As noted above, the plurality of client controllers 401 and the house server 141 are coupled using a wireless network 110. Each of the plurality of client controllers 401 are electrically coupled to devices under control 402-403 in which the particular client controller 401 activates and deactivates the devices under control 402-403 to implement a user command provided to the client controller 401.

A user may utilize a remote device 305 and touch switches that are integrated into the various furniture pieces in the corresponding room to provide a user command to the corresponding client controller 401. The client controller 401, either independently or with the assistance of the house server 141, determines the operations to be performed in response to the user command. The client controller 141 transmits device commands to one or more of the appropriate devices under control 402-403 that cause the devices under control to perform the operations associated with the user command.

The house server 141 contains a set of server computing components 421-424 and the attached database 142 to perform its functions. The set of server computing components 421-424 comprises a server controller 421, a server network interface 422, a user account manager 423, and a database interface 424 coupled to the database devices 142.

The server controller 421 receives user commands from the client controllers 401 via the device network interface 412 when an action is requested by a user. The server controller 421 interacts with the remaining device set of server computing components 421-424 to generate commands for taking action with respect to the attached device. The server controller 421 also may interact with the database interface 424 and the user account manager 423 to authorize a user command to be performed based upon an identity of the user generating the user command.

The server network interface 422 connects the house server 141 to the wireless network 110 to send and receive communication from users and controllers. The server network interface 422 performs all necessary data formatting, data packet creation, data encryption for security, and data transmission and reception when the server 141 communicates with other processing systems disclosed herein. The server network interface 422 is also responsible to ensure reception of any communications to other computing systems and to log any errors or attempts to hack into the database.

The user account manager 423 is responsible for creating and managing user accounts for the residents and guests of the house 100. The user account manager 423 also is used in authenticating a user based upon user input. Typically, the user input uses a username and password. Multi-factor authentication, use of one-time passwords, and similar secure authentication mechanisms may be included in the user profile. For every sign in the system will recognize the user type, i.e. resident and guest, along with all past activities from account details in the database. Based on user type, the various controller behaviors will change.

The database interface 424 coupled to the database devices 142 connects the set of server computing components 421-424 to data storage devices to maintain user data and preferences, device configuration data in the various rooms supported by client controllers, program routines and libraries, and user account and security information needed to operate the controllers and attached devices. The database interface 424 may consist of a device interface with the necessary device drivers needed to store and retrieve data. The database interface 424 also may consist of a database engine to store and retrieve large amounts of searchable data including security logs, images, and videos that are generated and maintained by the house computing system 400.

Each of the client controllers 401 comprise a set of client computing components that include a device controller 411, a client network interface 412, a device interface 413, and a remote receiver 414. These components work together to perform the operations of the client controller 401.

The device controller 411 receives user commands from the remote receiver 414 or from the house server 141 via the device network interface 412 when requested by a user. The device controller 411 interacts with the remaining device set of processing components to generate commands for taking action with respect to the attached device. The device controller 411 also may send data to the house server 141 regarding command responses and device status as needed.

The client network interface 412 connects the client controller 401 to the wireless network 110 to send and receive communication from users and the house server 141. The client network interface 412 performs all necessary data formatting, data packet creation, data encryption for security, and data transmission and reception when the client controller 401 communicates with other processing systems disclosed herein. The client network interface 412 is also responsible to ensure reception of any communications to other computing systems and to log any errors or attempts to hack into the database.

The device interface 413 connects the client controller 401 to a first and second device under control 402-403 to send and receive communication from users and the house server 141. The device receiver 413 performs all necessary data formatting, data packet creation, data encryption for security, and data transmission and reception when the client controller 401 communicates with remote devices disclosed herein. The device interface 413 is also responsible to ensure reception of any communications to other computing systems and to log any errors or attempts to hack into the database.

The remote receiver 414 connects the client controller 401 to the wireless remote device 305 to send and receive communications from users and the house server 141. The remote receiver 414 performs all necessary data formatting, data packet creation, data encryption for security, and data transmission and reception when the client controller 401 communicates with remote devices disclosed herein. The remote receiver 414 is also responsible to ensure reception of any communications to other computing systems and to log any errors or attempts to hack into the database.

A first device under control 402 provides a control connection from the client controller 401 to a particular device to be activated and deactivated. For example, a light emitting device that is coupled to a bedroom furniture piece as described in reference to FIGS. 3a-b is a device that is turned on and off in response to a user input received from a remote device 305. The first device under control 402 typically connects some device within the room that contains a finite number of operating states that the first device under control 402 operates. For example, the light emitting devices noted above typically have an on and an off state. These light emitting devices may also have a set of supported colors and intensity levels. The first device under control 402 typically receives one or more device commands from the client controller 401 that statically changes the first device under control 402 until a subsequent device command is received. Control logic such as timers and alarms that may be supported by the first device under control 402 are maintained and generated in the client controller 401.

The second device under control 403 also provides a control connection from the client controller 401 to a particular device to be activated and deactivated. In contrast to the first device under control 402, the second device under control 403 may include a plurality of device actuators 432a-n each of which is coupled to a different device within the room that contains a larger number of operating states that the second device under control 403 operates. Additionally, the second device under control 403 also comprises a device sequencer 431 that changes the individual device actuators 432a-n in a particular order and at different times. The second device under control 403 typically receives one or more device commands from the client controller 401 that initiates a sequence of operations as specified within the device sequencer 431. The client controller 401 may provide the sequence of actions to the device sequencer 431, and any timing information associated with each of the actions, before initiating the sequence of actions to occur. Alternately, one or more sequences of actions may be loaded and stored within the device sequencer 431. In the alternate embodiment, the client controller 401 may send a command to perform a stored sequence of actions to the device sequencer 431 and all further control logic such as timers and alarms that may be supported by the second device under control 403 are maintained and generated in the device sequencer 431.

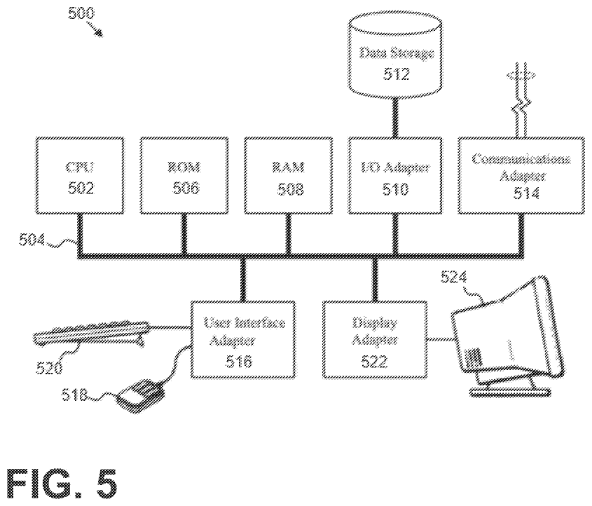

FIG. 5 illustrates a generalized schematic of a programmable processing system utilized as the various computing components described herein used to implement an embodiment of the present invention. FIG. 5 shows a computer system 500 adapted according to certain embodiments of the server and/or the user interface device. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 also may include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 110, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical and/or logical.

The applications of the present disclosure are not limited to the architecture of the computer system 500. Rather the computer system 500 is provided as an example of one type of computing device that may be adapted to perform the functions of a server 105 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 500 may be virtualized for access by multiple users and/or applications.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristic.

What is claimed is:

1. A system for providing high tech furniture for a home, the home comprising a dining room, a kitchen, and a bedroom, the system comprising:
a house server communicatively connected to a database;
a plurality of controllers, the plurality of controllers communicatively connected to the house server and the database by a wireless hotspot;
the plurality of controllers comprising a dining room controller, a kitchen controller, and a bedroom controller;
a food tray dispenser, wherein the kitchen controller is operable to receive inputs for a plurality of locations for a plurality of food items within the food tray dispenser;
the food tray dispenser comprising a central processing unit, wherein the central processing unit of the food tray dispenser is operable to instruct the food tray dispenser to move from the kitchen to the dining room;
wherein the food tray dispenser is operable to connect to a table located in the dining room, and the dining room controller is operable to receive inputs selecting one of the plurality of food items; and
wherein the food tray dispenser is operable to dispense the one of the plurality of food items to a dispersal and retrieving center connected to the table.

2. The system of claim 1 further comprising a waste removal system, wherein the waste removal system is integral with the food tray dispenser.

3. The system of claim 2 wherein the waste removal system comprises a gate for loading a plurality of dirty plates.

4. The system of claim 3 wherein the waste removal system further comprises a turning brush that is operable to clear debris from the plurality of dirty plates and dump the debris into a trash container through a chute within the waster removal system.

5. The system of claim 1 further comprising an open hole located on a side of the table, the open hole connected to a first clear glass roller, wherein the food tray dispenser connects to the table by connecting to the open hole.

6. The system of claim 1 further comprising a plurality of buttons located on the table corresponding to a plurality of seated chairs, wherein pressing one of the plurality of buttons instructs the one of the dining room controller or the food tray dispenser to perform an action.

7. The system of claim 1 further comprising a bed, a dresser, and a nightstand located within the bedroom, wherein the dresser comprises a plurality of drawers and the nightstand comprises a plurality of drawers.

8. The system of claim 7 wherein the plurality of drawers for the dresser and the plurality of drawers for the nightstand each comprise a hand touch sensor that is operable to cause the drawers to open by a touch.

9. The system of claim 7 wherein the dresser comprises a mirror that is operable to become a television.

10. A method of using a system for providing high tech furniture for a home, the home comprising a dining room, a kitchen, and a bedroom, the system comprising:
a house server communicatively connected to a database;
a plurality of controllers, the plurality of controllers communicatively connected to the house server and the database by a wireless hotspot;
the plurality of controllers comprising a dining room controller, a kitchen controller, and a bedroom controller;
the method comprising a plurality of steps of:
loading a food tray dispenser with a plurality of food items;
serving the plurality of food items to a dispersal and retrieving center located on a table by the food tray dispenser;
retrieving a plurality of dirty plates from the dispersal and retrieving center by the food tray dispenser; and
cleaning the plurality of dirty plates by a waste removal system integral with the food tray dispenser.
